(19) United States
(12) Patent Application Publication
(10) Pub. No.: US 2022/0008871 A1
(43) Pub. Date: Jan. 13, 2022

(54) COMPOSITE FILMS AND METHODS OF MAKING AND USE THEREOF

(71) Applicant: BOARD OF REGENTS, THE UNIVERSITY OF TEXAS SYSTEM, Austin, TX (US)

(72) Inventors: Delia MILLIRON, Austin, TX (US); Gary ONG, Temecula, CA (US)

(21) Appl. No.: 17/289,307

(22) PCT Filed: Oct. 30, 2019
(86) PCT No.: PCT/US2019/058719

§ 371 Date: Apr. 28, 2021

Related U.S. Application Data
(60) Provisional application No. 62/753,271, filed on Oct. 31, 2018.

(51) Int. Cl. B01D 69/14; H01M 8/1051; C25B 13/08; B01D 67/00; B01D 69/02; B01D 71/02; B01D 69/12

(52) U.S. Cl. CPC B01D 69/148; H01M 8/1051; C25B 13/08; H01M 2008/1095; B01D 69/02; B01D 71/024; B01D 69/122; B01D 67/0079

(57) ABSTRACT

Disclosed herein are composite films comprising a plurality of nanostructured metal oxide crystals dispersed within a proton conducting polymer phase, wherein the plurality of nanostructured metal oxide crystals have an average particle size of from 1 nm to 20 nm, and wherein the composite film comprises from 20% to 90% by volume of the plurality of nanostructured metal oxide crystals relative to the composite film. The composite film can have a proton conductivity of 10⁻⁸ S/cm or more at a temperature of 100° C. or more.

### CROSS-REFERENCE TO RELATED APPLICATIONS

This application claims the benefit of priority to U.S. Provisional Application No. 62/753,271, filed Oct. 31, 2018, which is hereby incorporated herein by reference in its entirety.

### BACKGROUND

Proton exchange membranes are used to transport protons between the anode and cathode during charging and discharging in proton exchange membrane fuel cells (PEMFCs) or in some electrochromic devices. There is a current push to run PEMFCs at higher temperatures, e.g. above 100° C., for gains in electrochemical efficiency and stability. However, there are a limited number of materials that exhibit proton conduction above 100° C., and those that exist either exhibit stability issues, scalability issues, or insufficient performance. The existing ideas usually utilize solid versions of acids that have excess protons (these are unstable under humid conditions), organic-inorganic materials where an inorganic component (usually a metal hydrate) is mixed with an organic polymer where proton conduction comes from water molecules retained by the hydrate (the water molecules eventually desorb at high temperatures negating their beneficial effects), and various organic coating layers that help prevent dehumidification of the membrane. As such, a need exists for a material that exhibits stable and sufficient proton conduction above 100° C. in addition to conductivity under ambient conditions. The compositions and methods discussed herein addresses this and other needs.

### SUMMARY

In accordance with the purposes of the disclosed compositions and methods, as embodied and broadly described herein, the disclosed subject matter relates to composite films and methods of making and use thereof.

In some examples, disclosed herein are composite films comprising a plurality of nanostructured metal oxide crystals dispersed within a proton conducting polymer phase, wherein the plurality of nanostructured metal oxide crystals have an average particle size of from 1 nm to 20 nm, and wherein the composite film comprises from 20% to 90% by volume of the plurality of nanostructured metal oxide crystals relative to the composite film.

In some examples, the plurality of nanostructured metal oxide crystals comprise a reducible metal oxide. In some examples, the plurality of nanostructured metal oxide crystals comprise niobium oxide, titanium oxide, tungsten oxide, zirconium oxide, hafnium oxide, magnesium oxide, vanadium oxide, iron oxide, chromium oxide, manganese oxide, nickel oxide, cerium oxide, gadolinium oxide, samarium oxide, or a combination thereof. In some examples, the plurality of nanostructured metal oxide crystals comprise niobium oxide, titanium oxide, tungsten oxide, hafnium oxide, vanadium oxide, iron oxide, chromium oxide, manganese oxide, nickel oxide, cerium oxide, gadolinium oxide, samarium oxide, or a combination thereof. In some examples, the plurality of nanostructured metal oxide crystals comprise cerium oxide. In some examples, the plurality of nanostructured metal oxide crystals comprise cerium oxide doped with one or more dopants. In some examples, the plurality of nanostructured metal oxide crystals comprise gadolinium doped cerium oxide, samarium doped cerium oxide, or a combination thereof.

In some examples, each of the plurality of nanostructured metal oxide crystals has at least one dimension that is from 1 nm to 5 nm in size. In some examples, the plurality of nanostructured metal oxide crystals have an average particle shape that is substantially isotropic. In some examples, the plurality of nanostructured metal oxide crystals have an average particle size of from 1 nm to 10 nm.

In some examples, the plurality of nanostructured metal oxide crystals are substantially free of ligands and/or capping materials.

In some examples, the proton conducting polymer phase comprises a polyether, a polysulfonate, a polysulfone, a poly(imidazole), a triazole, a benzimidazole, a polyester, a polycarbonate, a polymer derived from a pyridine monomer, derivatives thereof, or combinations thereof. In some examples, the proton conducting polymer phase comprises a polyether or a derivative thereof. In some examples, the proton conducting polymer phase comprises polyethylene oxide, polyetherpyridine, polyether ether ketone (PEEK), polytetrahydrofuran, polyvinyl butyral, polybenzimidazole, derivatives thereof, or combinations thereof. In some examples, the proton conducting polymer comprises polyethylene oxide, polytetrahydrofuran, derivatives thereof, or combinations thereof.

In some examples, the composite film comprises from 30% to 90%, from 20% to 70%, or from 20% to 50% by volume of the plurality of nanostructured metal oxide crystals relative to the composite film. In some examples, the composite film has an average thickness of from 100 nm to 500 μm, from 1 μm to 500 μm, or from 10 μm to 100 μm. In some examples, the composite film has a proton conductivity of 10⁻⁸ S/cm or more, 10⁻⁶ S/cm or more, 10⁻⁴ S/cm or more, 0.01 S/cm or more, or 0.1 S/cm or more at a temperature of 25° C. or more, 100° C. or more, 200° C. or more, or 300° C. or more. In some examples, the composite film forms a free standing membrane. In some examples, the composite film is supported by a substrate.

Also disclosed herein are methods of making any of the composite films described herein, the methods comprising: dispersing the plurality of nanostructured metal oxide crystals and the polymer comprising the proton conducting polymer phase in a solvent, thereby forming a dispersion; and depositing the dispersion on a substrate; thereby forming the composite film.

In some examples, the solvent comprises tetrahydrofuran (THF), dimethylformamide (DMF), N-methylformamide, formamide, acetonitrile, dimethylacetamide, propylene carbonate, ethylene carbonate, n-methylpyrrolidone, dimethylsulfoxide, or a combination thereof. In some examples, the solvent comprises dimethylformamide, dimethylacetamide, acetonitrile, or a combination thereof.

In some examples, depositing the dispersion comprises printing, spin coating, drop-casting, zone casting, dip coating, blade coating, spraying, vacuum filtration, slot die coating, curtain coating, or combinations thereof. In some examples, depositing the dispersion comprises spin coating.

In some examples, the methods further comprise removing the composite film from the substrate. In some examples, the methods further comprise making the plurality of nanostructured metal oxide crystals. In some examples, the methods comprise removing ligands and/or capping agents from the plurality of nanostructured metal oxide crystals such that the plurality of nanostructured metal oxide crystals can be substantially free of ligands and/or capping materials.

Also disclosed herein are devices comprising the any of the composite films described herein, wherein the devices can comprise a fuel cell, an electrolytic cell, a proton exchange electrolyzer, or a battery. In some examples, the device comprises a proton exchange membrane fuel cell (PEMFC). In some examples, the device is operated at a temperature of 25° C. or more, 50° C. or more, 100° C. or more, 200° C. or more, or 300° C. or more.

Also disclosed herein are methods of use of any of the composite films described herein, the methods comprising using the composite film as a proton exchange membrane, as an ion exchange membrane, as a hydrogen separation membrane, as a solid electrolyte, or a combination thereof. Also disclosed herein are methods of use of any of the composite films described herein, the methods comprising using the composite film in a fuel cell. In some examples, the method comprises using the composite film as the proton exchange membrane in a proton exchange membrane fuel cell (PEMFC). In some examples, the method is conducted at a temperature of 25° C. or more, 50° C. or more, 100° C. or more, 200° C. or more, or 300° C. or more.

Also disclosed herein are methods of use of any of the composite films described herein, the methods comprising using the composite film in electrolysis, in reversible electrodialysis, in a chloroalkali system, or combinations thereof.

Additional advantages of the disclosed compositions and methods will be set forth in part in the description which follows, and in part will be obvious from the description. The advantages of the disclosed compositions and methods will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 is an Ellingham construction depicting the oxidation of cerium oxide.

FIG. 2 is an Ellingham construction depicting the oxidation of cerium oxide.

FIG. 3 is a scanning transmission electron microscopy (SEM) image of CeO₂ nanocrystals.

FIG. 4 is an X-ray diffraction of CeO₂ nanocrystals.

FIG. 5 is a scanning microscopy image of a composite film comprising 50:50 nanocrystal:polymer volume fraction.

FIG. 6 is a scanning microscopy image of a composite film comprising 50:50 nanocrystal:polymer volume fraction.

FIG. 7 is the ionic conductivity of CeO₂ only film.

FIG. 8 is the ionic conductivity of PEO only film.

FIG. 9 is the ionic conductivity of CeO₂-PEO composite film.

FIG. 10 is the ionic conductivity of CeO₂-polybenzimidazole composite film.

### DETAILED DESCRIPTION

The compositions, devices, and methods described herein may be understood more readily by reference to the following detailed description of specific aspects of the disclosed subject matter and the Examples included therein.

Before the present compositions, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

Composite Films

Disclosed herein are composite films comprising a plurality of nanostructured metal oxide crystals dispersed within an ion conducting polymer phase (e.g., a proton conducting polymer phase). As used herein, “nanostructured” means any structure with one or more nanosized features. A nanosized feature can be any feature with at least one dimension 20 nanometers (nm) or less in size (e.g., 10 nm or less). For example, a nanosized feature can comprise a nanowire, nanotube, nanoparticle, nanopore, and the like, or combinations thereof. As such, each of the plurality of nanostructured metal oxide crystals can comprise, for example, a nanowire, nanotube, nanoparticle, nanopore, or a combination thereof. In some examples, each of the plurality of nanostructured metal oxide crystals can comprise a metal oxide crystal that is not nanosized but has been modified with a nanowire, nanotube, nanoparticle, nanopore, or a combination thereof.

“Phase,” as used herein, generally refers to a region of a material having a substantially uniform composition which is a distinct and physically separate portion of a heterogeneous system. The term “phase” does not imply that the material making up a phase is a chemically pure substance, but merely that the chemical and/or physical properties of the material making up the phase are essentially uniform throughout the material, and that these chemical and/or physical properties differ significantly from the chemical and/or physical properties of another phase within the material. Examples of physical properties include density, thickness, aspect ratio, specific surface area, porosity and dimensionality. Examples of chemical properties include chemical composition.

The plurality of nanostructured metal oxide crystals can, for example, have a high average total surface, comprise a reducible metal oxide, have a low oxygen vacancy defect formation energy, have a high isoelectric point, be substantially electronically insulating, have a high surface oxygen vacancy concentration, or a combination thereof.

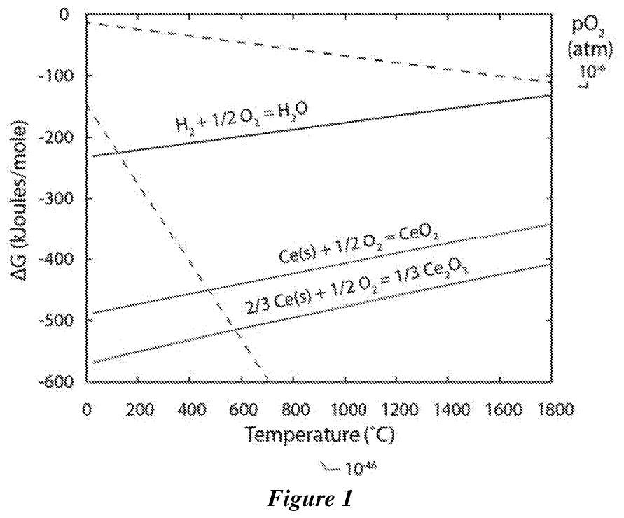

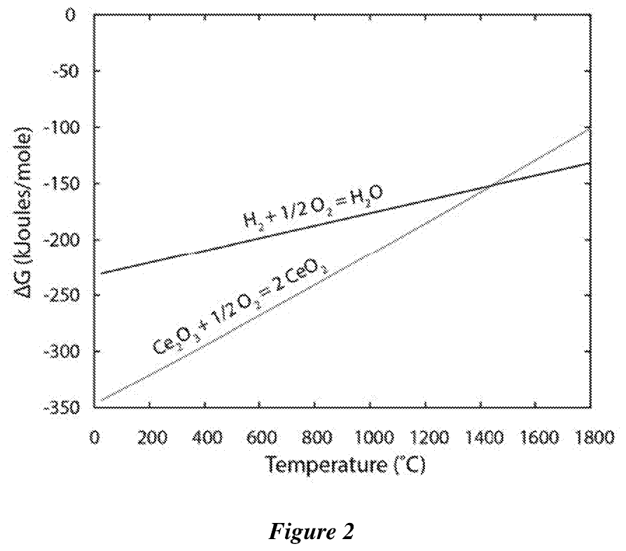

The plurality of nanostructured metal oxide crystals can comprise any suitable metal oxide, optionally doped with one or more dopants. For example, the plurality of nanostructured metal oxide crystals can comprise a reducible metal oxide. As used herein, a “reducible metal oxide” generally refers to an oxide of a metal, wherein the metal comprises a metal that can hold difference valence states (e.g., one or more of +1, +2, +3, +4, +5, etc.) in bulk form or as defect states on the surface of the metal oxide. For example, a reducible metal oxide comprises a metal oxide where, in an Ellingham construction depicting the oxidation of the metal oxide with the same cationic component, the curve of the metal oxide is lower than the hydrogen, oxygen, and water equilibrium to suggest that the metal oxide will be oxidized in the presence of water vapor with a concurrent reduction of water to form adsorbed hydrogen or hydrogen gas, for example as shown for cerium oxide in FIG. 1 and FIG. 2.

In some examples, the plurality of nanostructured metal oxide crystals can comprise niobium oxide, titanium oxide, silicon oxide, tungsten oxide, zirconium oxide, hafnium oxide, magnesium oxide, vanadium oxide, iron oxide, chromium oxide, manganese oxide, nickel oxide, cerium oxide, gadolinium oxide, samarium oxide, or a combination thereof. In some examples, the plurality of nanostructured metal oxide crystals can comprise niobium oxide, titanium oxide, tungsten oxide, hafnium oxide, vanadium oxide, iron oxide, chromium oxide, manganese oxide, nickel oxide, cerium oxide, gadolinium oxide, samarium oxide, or a combination thereof. In some examples, the plurality of nanostructured metal oxide crystals can comprise cerium oxide. The plurality of nanostructured metal oxide crystals can, in certain examples, comprise cerium oxide doped with one or more dopants, such as one or more aliovalent acceptor dopants (e.g., trivalent acceptor dopants). In some examples, the plurality of nanostructured metal oxide crystals can comprise gadolinium doped cerium oxide, samarium doped cerium oxide, or a combination thereof. The plurality of nanostructured metal oxide crystals can, in some examples, be substantially free of ligands and/or capping materials.

The plurality of nanostructured metal oxide crystals can comprise crystals of any shape (e.g., a sphere, a rod, a quadrilateral, an ellipse, a triangle, a polygon, etc.). In some examples, the plurality of nanostructured metal oxide crystals can have an isotropic shape. In some examples, the plurality of nanostructured metal oxide crystals can have an anisotropic shape. In some examples, the shape of the plurality of nanostructured metal oxide crystals can be selected to expose a particular facet. In certain examples, the shape of the plurality of nanostructured metal oxide crystals can be selected to expose a (100) facet.

In some examples, each of the plurality of nanostructured metal oxide crystals can have at least one dimension that is 20 nm or less in size (e.g., 19.5 nm or less, 19 nm or less, 18.5 nm or less, 18 nm or less, 17.5 nm or less, 17 nm or less, 16.5 nm or less, 16 nm or less, 15.5 nm or less, 15 nm or less, 14.5 nm or less, 14 nm or less, 13.5 nm or less, 13 nm or less, 12.5 nm or less, 12 nm or less, 11.5 nm or less, 11 nm or less, 10.5 nm or less, 10 nm or less, 9.75 nm or less, 9.5 nm or less, 9.25 nm or less, 9 nm or less, 8.75 nm or less, 8.5 nm or less, 8.25 nm or less, 8 nm or less, 7.75 nm or less, 7.5 nm or less, 7.25 nm or less, 7 nm or less, 6.75 nm or less, 6.5 nm or less, 6.25 nm or less, 6 nm or less, 5.75 nm or less, 5.5 nm or less, 5.25 nm or less, 5 nm or less, 4.75 nm or less, 4.5 nm or less, 4.25 nm or less, 4 nm or less, 3.75 nm or less, 3.5 nm or less, 3.25 nm or less, 3 nm or less, 2.75 nm or less, 2.5 nm or less, 2.25 nm or less, or 2 nm or less). In some examples, each of the plurality of nanostructured metal oxide crystals can have at least one dimension that is 1 nm or more in size (e.g., 1.25 nm or more, 1.5 nm or more, 1.75 nm or more, 2 nm or more, 2.25 nm or more, 2.5 nm or more, 2.75 nm or more, 3 nm or more, 3.25 nm or more, 3.5 nm or more, 3.75 nm or more, 4 nm or more, 4.25 nm or more, 4.5 nm or more, 4.75 nm or more, 5 nm or more, 5.25 nm or more, 5.5 nm or more, 5.75 nm or more, 6 nm or more, 6.25 nm or more, 6.5 nm or more, 6.75 nm or more, 7 nm or more, 7.25 nm or more, 7.5 nm or more, 7.75 nm or more, 8 nm or more, 8.25 nm or more, 8.5 nm or more, 8.75 nm or more, 9 nm or more, 9.25 nm or more, 9.5 nm or more, 9.75 nm or more, 10 nm or more, 10.5 nm or more, 11 nm or more, 11.5 nm or more, 12 nm or more, 12.5 nm or more, 13 nm or more, 13.5 nm or more, 14 nm or more, 14.5 nm or more, 15 nm or more, 15.5 nm or more, 16 nm or more, 16.5 nm or more, 17 nm or more, 17.5 nm or more, 18 nm or more, 18.5 nm or more, or 19 nm or more). Each of the plurality of nanostructured metal oxide crystals can have at least one dimension that ranges in size from any of the minimum values described above to any of the maximum values described above. For example, each of the plurality of nanostructured metal oxide crystals can have at least one dimension that is from 1 nm to 20 nm in size (e.g., from 1 nm to 10 nm, from 10 nm to 20 nm, from 1 nm to 5 nm, from 5 nm to 10 nm, from 10 nm to 15 nm, from 15 nm to 20 nm, from 1 nm to 4 nm, from 4 nm to 7 nm, from 7 nm to 10 nm, from 10 nm to 13 nm, from 13 nm to 16 nm, from 16 nm to 20 nm, from 1 nm to 15 nm, from 2 nm to 20 nm, or from 2 nm to 9 nm). As used herein, the size of the at least one dimension of each of the plurality of nanostructured metal oxide crystals is determined by electron microscopy.

In some examples, the plurality of nanostructured metal oxide crystals can have an average particle size. “Average particle size” and “mean particle size” are used interchangeably herein, and generally refer to the statistical mean particle size of the particles (or crystals) in a population of particles (or crystals). For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. For an anisotropic particle, the average particle size can refer to, for example, the average maximum dimension of the particle (e.g., the length of a rod shaped particle, the diagonal of a cube shape particle, the bisector of a triangular shaped particle, etc.) For an anisotropic particle, the average particle size can refer to, for example, the hydrodynamic size of the particle. Mean particle size can be measured using methods known in the art, such as evaluation by scanning electron microscopy, transmission electron microscopy, and/or dynamic light scattering. As used herein, the average particle size is determined by electron microscopy.

The plurality of nanostructured metal oxide crystals can, for example, have an average particle size of 1 nm or more (e.g., 1.25 nm or more, 1.5 nm or more, 1.75 nm or more, 2 nm or more, 2.25 nm or more, 2.5 nm or more, 2.75 nm or more, 3 nm or more, 3.25 nm or more, 3.5 nm or more, 3.75 nm or more, 4 nm or more, 4.25 nm or more, 4.5 nm or more, 4.75 nm or more, 5 nm or more, 5.25 nm or more, 5.5 nm or more, 5.75 nm or more, 6 nm or more, 6.25 nm or more, 6.5 nm or more, 6.75 nm or more, 7 nm or more, 7.25 nm or more, 7.5 nm or more, 7.75 nm or more, 8 nm or more, 7.25 nm or more, 8.5 nm or more, 8.75 nm or more, 9 nm or more, 9.25 nm or more, 9.5 nm or more, 9.75 nm or more, 10 nm or more, 10.5 nm or more, 11 nm or more, 11.5 nm or more, 12 nm or more, 12.5 nm or more, 13 nm or more, 13.5 nm or more, 14 nm or more, 14.5 nm or more, 15 nm or more, 15.5 nm or more, 16 nm or more, 16.5 nm or more, 17 nm or more, 17.5 nm or more, 18 nm or more, 18.5 nm or more, 19 nm or more, 19.5 nm or more, 20 nm or more, 21 nm or more, 22 nm or more, 23 nm or more, 24 nm or more, 25 nm or more, 30 nm or more, 35 nm or more, 40 nm or more, 45 nm or more, 50 nm or more, 60 nm or more, 70 nm or more, or 80 nm or more).

In some examples, the plurality of nanostructured metal oxide crystals can have an average particle size of 100 nm or less (e.g., 90 nm or less, 80 nm or less, 70 nm or less, 60 nm or less, 50 nm or less, 45 nm or less, 40 nm or less, 35 nm or less, 30 nm or less, 25 nm or less, 24 nm or less, 23 nm or less, 22 nm or less, 21 nm or less, 20 nm or less, 19.5 nm or less, 19 nm or less, 18.5 nm or less, 18 nm or less, 17.5 nm or less, 17 nm or less, 16.5 nm or less, 16 nm or less, 15.5 nm or less, 15 nm or less, 14.5 nm or less, 14 nm or less, 13.5 nm or less, 13 nm or less, 12.5 nm or less, 12 nm or less, 11.5 nm or less, 11 nm or less, 10.5 nm or less, 10 nm or less, 9.75 nm or less, 9.5 nm or less, 9.25 nm or less, 9 nm or less, 8.75 nm or less, 8.5 nm or less, 8.25 nm or less, 8 nm or less, 7.75 nm or less, 7.5 nm or less, 7.25 nm or less, 7 nm or less, 6.75 nm or less, 6.5 nm or less, 6.25 nm or less, 6 nm or less, 5.75 nm or less, 5.5 nm or less, 5.25 nm or less, 5 nm or less, 4.75 nm or less, 4.5 nm or less, 4.25 nm or less, 4 nm or less, 3.75 nm or less, 3.5 nm or less, 3.25 nm or less, 3 nm or less, 2.75 nm or less, 2.5 nm or less, 2.25 nm or less, or 2 nm or less).

The average particle size of the plurality of nanostructured metal oxide nanocrystals can range from any of the minimum values described above to any of the maximum values described above. For example, the plurality of nanostructured metal oxide nanocrystals can have an average particle size of from 1 nm to 100 nm (e.g., from 1 nm to 50 nm, from 50 nm to 100 nm, from 1 nm to 20 nm, from 20 nm to 40 nm, from 40 nm to 60 nm, from 60 nm to 80 nm, from 80 nm to 100 nm, from 1 nm to 40 nm, from 1 nm to 30 nm, from 1 nm to 20 nm, from 1 nm to 10 nm, from 10 nm to 20 nm, from 1 nm to 5 nm, from 5 nm to 10 nm, from 10 nm to 15 nm, from 15 nm to 20 nm, from 1 nm to 4 nm, from 4 nm to 7 nm, from 7 nm to 10 nm, from 10 nm to 13 nm, from 13 nm to 16 nm, from 16 nm to 20 nm, from 1 nm to 15 nm, from 5 nm to 20 nm, from 5 nm to 15 nm, from 2 nm to 10 nm, from 1 nm to 9.5 nm, from 1 nm to 9 nm, from 1 nm to 8.5 nm, from 1 nm to 8 nm, from 1 nm to 7.5 nm, from 1 nm to 7 nm, from 1 nm to 6.5 nm, from 1 nm to 6 nm, from 1 nm to 5.5 nm, or from 2 nm to 9 nm).

In some examples, the plurality of nanostructured metal oxide crystals can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the average particle size, within 15% of the average particle size, within 10% of the average particle size, or within 5% of the average particle size).

In some examples, the plurality of nanostructured metal oxide crystals can comprise cerium oxide and each of the plurality of nanostructured metal oxide crystals can have at least one dimension that is from 1 nm to 5 nm in size. In some examples, the plurality of nanostructured metal oxide crystals can comprise cerium oxide, have an average particle shape that is substantially isotropic, and have an average particle size of from 1 nm to 10 nm.

In some examples, the plurality of nanostructured metal oxide crystals can comprise cerium oxide, each of the plurality of nanostructured metal oxide crystals can have at least one dimension that is from 1 nm to 5 nm in size, and the plurality of nanostructured metal oxide crystals can have a shape that exposes a (100) facet, such as a cubic shape or a platelet shape. In some examples, the plurality of nanostructured metal oxide crystals can comprise cerium oxide, have an average particle shape that exposes a (100) facet, and have an average particle size of from 1 nm to 10 nm.

The ion conducting polymer phase can, for example, have a high ionic mobility, be substantially thermally stable, be substantially mechanically stable, have a low glass transition temperature, have a high segmental chain mobility, have a low temperature of crystallization, be amorphous, or a combination thereof.

In some examples, the ion conducting polymer phase can comprise a proton conducting polymer phase. The proton conducting polymer phase can, for example, have a high ionic mobility, be substantially thermally stable, be substantially mechanically stable, have a low glass transition temperature, have a high segmental chain mobility, have a low temperature of crystallization, be amorphous, or a combination thereof.

The proton conducting polymer phase can, for example, comprise a polymer electrolyte, such as those known in the art. For example, the proton conducting polymer phase can comprise any of those described in Kreuer, “Ion Conducting Membranes for Fuel Cells and other Electrochemical Devices,” Chem. Mater., 2014, 26, 361-380; Hickner et al. “Alternate Polymer Systems for Proton Exchange Membranes (PEMs),” Chem. Rev., 2004, 104, 4587-4612; Cheng et al. “Gel Polymer Electrolytes for Electrochemical Energy Storage,” Adv. Ener. Mat., 2018, 8, 1702184; Meyer, “Polymer Electrolytes for Lithium-Ion Batteries,” Adv. Mat., 1998, 10, 439-448; Hallinan et al. “Polymer Electrolytes,” Annu. Rev. Mater. Res 2013, 43, 503-525; and Mindemark et al. “Beyond PEO—Alternate host materials for Li conducting solid polymer electrolytes,” Progress in Polymer Science 2018, 81, 114-143; each of which is hereby incorporated by reference herein in its entirety for its teaching on polymers. In some examples, the proton conducting polymer phase can comprise any polymer comprising one or more basic functional groups (e.g., ether, pyridine, sulfonate, etc.).

The proton conducting polymer phase can, for example, comprise a polyether, a polysulfonate, a polysulfone, a poly(imidazole), a triazole, a benzimidazole, a polyester, a polycarbonate, a polymer derived from a pyridine monomer, derivatives thereof, or combinations thereof. In some examples, the proton conducting polymer phase can comprise a polyether or a derivative thereof. In some examples, the proton conducting polymer phase can comprise polyethylene oxide, polyetherpyridine, polyether ether ketone (PEEK), polytetrahydrofuran, polyvinyl butyral, polybenzimidazole, derivatives thereof, or combinations thereof. In certain examples, the proton conducting polymer can comprise polyethylene oxide, polytetrahydrofuran, derivatives thereof, or combinations thereof.

In some examples, the plurality of nanostructured metal oxide crystals can comprise cerium oxide, each of the plurality of nanostructured metal oxide crystals can have at least one dimension that is from 1 nm to 5 nm in size, and the proton conducting polymer can comprise polyethylene oxide, polytetrahydrofuran, derivatives thereof, or combinations thereof. In some examples, the plurality of nanostructured metal oxide crystals can comprise cerium oxide, have an average particle shape that is substantially isotropic, and have an average particle size of from 1 nm to 10 nm, and the proton conducting polymer can comprise polyethylene oxide, polytetrahydrofuran, derivatives thereof, or combinations thereof.

The composite film can, for example, comprise 20% or more by volume of the plurality of nanostructured metal oxide crystals relative to the composite film (e.g., 21% or more, 22% or more, 23% or more, 24% or more, 25% or more, 26% or more, 27% or more, 28% or more, 29% or more, 30% or more, 31% or more, 32% or more, 33% or more, 34% or more, 35% or more, 36% or more, 37% or more, 38% or more, 39% or more, 40% or more, 41% or more, 42% or more, 43% or more, 44% or more, 45% or more, 46% or more, 47% or more, 48% or more, 49% or more, 50% or more, 51% or more, 52% or more, 53% or more, 54% or more, 55% or more, 56% or more, 57% or more, 58% or more, 59% or more, 60% or more, 61% or more, 62% or more, 63% or more, 64% or more, 65% or more, 66% or more, 67% or more, 68% or more, 69% or more, 70% or more, 71% or more, 72% or more, 73% or more, 74% or more, 75% or more, 76% or more, 77% or more, 78% or more, 79% or more, 80% or more, 81% or more, 82% or more, 83% or more, 84% or more, or 85% or more).

In some examples, the composite film can comprise 90% or less by volume of the plurality of nanostructured metal oxide crystals relative to the composite film (e.g., 89% or less, 88% or less, 87% or less, 86% or less, 85% or less, 84% or less, 83% or less, 82% or less, 81% or less, 80% or less, 79% or less, 78% or less, 77% or less, 76% or less, 75% or less, 74% or less, 73% or less, 72% or less, 71% or less, 70% or less, 69% or less, 68% or less, 67% or less, 66% or less, 65% or less, 64% or less, 63% or less, 62% or less, 61% or less, 60% or less, 59% or less, 58% or less, 57% or less, 56% or less, 55% or less, 54% or less, 53% or less, 52% or less, 51% or less, 50% or less, 49% or less, 48% or less, 47% or less, 46% or less, 45% or less, 44% or less, 43% or less, 42% or less, 41% or less, 40% or less, 39% or less, 38% or less, 37% or less, 36% or less, 35% or less, 34% or less, 33% or less, 32% or less, 31% or less, 30% or less, 29% or less, 28% or less, 27% or less, 26% or less, or 25% or less).

The amount of the plurality of nanostructured metal oxide crystals in the composite film can range from any of the minimum values described above to any of the maximum values described above. For example, the composite film can comprise from 20% to 90% by volume of the plurality of nanostructured metal oxide crystals relative to the composite film (e.g., from 20% to 55%, from 55% to 90%, from 20% to 30%, from 30% to 40%, from 40% to 50%, from 50% to 60%, from 60% to 70%, from 70% to 80%, from 80% to 90%, from 30% to 90%, from 20% to 80%, from 30% to 80%, from 30% to 70%, from 20% to 70%, from 30% to 60%, from 20% to 50%, or from 30% to 50%).

In some examples, the plurality of nanostructured metal oxide crystals can comprise cerium oxide, each of the plurality of nanostructured metal oxide crystals can have at least one dimension that is from 1 nm to 5 nm in size; the proton conducting polymer can comprise polyethylene oxide, polytetrahydrofuran, derivatives thereof, or combinations thereof; and the composite film can comprise from 20% to 70% by volume of the plurality of nanostructured metal oxide crystals. In some examples, the plurality of nanostructured metal oxide crystals can comprise cerium oxide, have an average particle shape that is substantially isotropic, and have an average particle size of from 1 nm to 10 nm; the proton conducting polymer can comprise polyethylene oxide, polytetrahydrofuran, derivatives thereof, or combinations thereof; and the composite film can comprise from 20% to 70% by volume of the plurality of nanostructured metal oxide crystals.

The composite film can, for example, have an average thickness of 100 nanometers (nm) or more (e.g., 150 nm or more, 200 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, μm) or more, 2 μm or more, 3 μm or more, 4 μm or more, 5 μm or more, 6 μm or more, 7 μm or more, 8 μm or more, 9 μm or more, 10 μm or more, 15 μm or more, 20 μm or more, 25 μm or more, 30 μm or more, 35 μm or more, 40 μm or more, 45 μm or more, 50 μm or more, 60 μm or more, 70 μm or more, 80 μm or more, 90 μm or more, 100 μm or more, 125 μm or more, 150 μm or more, 175 μm or more, 200 μm or more, 225 μm or more, 250 μm or more, 300 μm or more, 350 μm or more, or 400 μm or more). In some examples, the composite film can have an average thickness of 500 μm or less (e.g., 450 μm or less, 400 μm or less, 350 μm or less, 300 μm or less, 250 μm or less, 225 μm or less, 200 μm or less, 175 μm or less, 150 μm or less, 125 μm or less, 100 μm or less, 90 μm or less, 80 μm or less, 70 μm or less, 60 μm or less, 50 μm or less, 45 μm or less, 40 μm or less, 35 μm or less, 30 μm or less, 25 μm or less, 20 μm or less, 15 μm or less, 10 μm or less, 9 μm or less, 8 μm or less, 7 μm or less, 6 μm or less, 5 μm or less, 4 μm or less, 3 μm or less, 2 μm or less, 1 μm or less, 900 nm or less, 800 nm or less, 700 nm or less, 600 nm or less, 500 nm or less, 450 nm or less, 400 nm or less, 350 nm or less, 300 nm or less, 250 nm or less, or 200 nm or less).

The average thickness of the composite film can range from any of the minimum values described above to any of the maximum values described above. For example, the composite film can have an average thickness of from 100 nm to 500 μm (e.g., from 500 nm to 500 μm, from 1 μm to 500 μm, from 10 μm to 500 μm, from 10 μm to 400 μm, from 10 μm to 300 μm, from 10 μm to 200 μm, or from 10 μm to 100 μm). The average thickness of the composite film can be determined by methods known in the art, for example profilometry, cross-sectional electron microscopy, atomic force microscopy (AFM), ellipsometry, veneer calipers, micrometer gauges, or combinations thereof.

The plurality of nanostructured metal oxide crystals can, for example, demonstrate preferential adsorption of water on their surfaces and water dissociation at defect sites to both retain water and generate mobile protons at ambient temperatures or above (e.g., 25° C. or more, 100° C. or more), e.g. even at elevated temperatures (e.g., 100° C. or more), while the proton conducting polymer phase can, for example, provide a conductive pathway for the protons, to thereby dramatically increase the absolute protonic conductivity of the composite material (e.g., as described by Meng et. al, “Review: recent progress in low temperature proton conducting ceramics,” Journal of Materials Science 2019, 54, 9291-9312, which is hereby incorporated herein by reference in its entirety for its teaching on metal oxides).

The composite film can, for example, have a proton conductivity of 10⁻⁸ S/cm or more (e.g., 1×10⁻⁷ S/cm or more, 1×10⁻⁶ S/cm or more, 1×10⁻⁵ S/cm or more, 1×10⁻⁴ S/cm or more, 1×10⁻³ S/cm or more, 0.01 S/cm or more, or 0.1 S/cm or more) at a temperature of 25° C. or more (e.g., 30° C. or more, 35° C. or more, 40° C. or more, 45° C. or more, 50° C. or more, 60° C. or more, 70° C. or more, 80° C. or more, 90° C. or more, 100° C. or more, 150° C. or more, 200° C. or more, 250° C. or more, 300° C. or more, 350° C. or more, 400° C. or more, 450° C. or more, 500° C. or more, or 550° C. or more). In some examples, the composite film can have a proton conductivity of 1 S/cm or less (e.g., 0.1 S/cm or less, 0.01 S/cm or less, 1×10⁻³ S/cm or less, 1×10⁻⁴ S/cm or less, 1×10⁻⁵ S/cm or less, 1×10⁻⁶ S/cm or less, or 1×10⁻⁷ S/cm or less) at a temperature of 25° C. or more (e.g., 30° C. or more, 35° C. or more, 40° C. or more, 45° C. or more, 50° C. or more, 60° C. or more, 70° C. or more, 80° C. or more, 90° C. or more, 100° C. or more, 150° C. or more, 200° C. or more, 250° C. or more, 300° C. or more, 350° C. or more, 400° C. or more, 450° C. or more, 500° C. or more, or 550° C. or more). The proton conductivity of the composite film can range from any of the minimum values described above to any of the maximum values described above. For example, the composite film can have a proton conductivity of from 10⁻⁸ S/cm to 1 S/cm (e.g., from 10⁻⁸ S/cm to 10⁻⁴ S/cm, from 10⁻⁴ S/cm to 1 S/cm, from 10⁻⁸ S/cm to 10⁻⁶ S/cm, from 10⁻⁶ S/cm to 104 S/cm, from 104 S/cm to 10⁻² S/cm, from 10⁻² S/cm to 1 S/cm, from 10⁻⁶ S/cm to 1 S/cm, from 104 S/cm to 1 S/cm, from 0.01 S/cm to 1 S/cm, or from 0.1 S/cm to 1 S/cm) at a temperature of from 25° C. to 600° C. (e.g., from 25° C. to 300° C., from 300° C. to 600° C., from 25° C. to 100° C., from 100° C. to 350° C., from 350° C. to 600° C., from 100° C. to 200° C., from 200° C. to 300° C., from 300° C. to 400° C., from 400° C. to 500° C., from 500° C. to 600° C., from 100° C. to 600° C., from 100° C. to 450° C., or from 100° C. to 300° C.).

The composite film can, in some examples, form a free standing membrane. In some examples, the composite film is supported by a substrate. Examples of suitable substrates include, but are not limited to, polymers (e.g., porous polymers), glass fibers, glass, quartz, silicon, and combinations thereof.

In some examples, the plurality of nanostructured metal oxide crystals can comprise cerium oxide, each of the plurality of nanostructured metal oxide crystals can have at least one dimension that is from 1 nm to 5 nm in size; the proton conducting polymer can comprise polyethylene oxide, polytetrahydrofuran, derivatives thereof, or combinations thereof; and the composite film can have a proton conductivity of 10⁻⁸ S/cm or more at a temperature of 25° C. or more (e.g., 100° C. or more). In some examples, the plurality of nanostructured metal oxide crystals can comprise cerium oxide, have an average particle shape that is substantially isotropic, and have an average particle size of from 1 nm to 10 nm; the proton conducting polymer can comprise polyethylene oxide, polytetrahydrofuran, derivatives thereof, or combinations thereof; and the composite film can have a proton conductivity of 10⁻⁸ S/cm or more at a temperature of 25° C. or more (e.g., 100° C. or more).

In some examples, the plurality of nanostructured metal oxide crystals are intimately mixed with the proton conducting polymer phase within the composite film. In some examples, the plurality of nanostructured metal oxide crystals and the proton conducting polymer phase are not phase separated within the composite film.

Methods of Making

Also disclosed herein are methods of making any of the composite films described herein, the method comprising: dispersing the plurality of nanostructured metal oxide crystals and the polymer comprising the proton conducting polymer phase in a solvent, thereby forming a dispersion; and depositing the dispersion on a substrate, thereby forming the composite film. In some examples, the methods can further comprise removing the composite film from the substrate.

Examples of solvents include, but are not limited to, tetrahydrofuran (THF), dimethylformamide (DMF), N-methylformamide, formamide, acetonitrile, dimethylacetamide, propylene carbonate, ethylene carbonate, n-methylpyrrolidone, dimethylsulfoxide, or a combination thereof. In some examples, the solvent can comprise dimethylformamide, dimethylacetamide, acetonitrile, or a combination thereof.

Depositing the dispersion can, for example, comprise printing, spin coating, drop-casting, zone casting, dip coating, blade coating, spraying, vacuum filtration, slot die coating, curtain coating, or combinations thereof. In some examples, depositing the dispersion can comprise spin coating.

In some examples, the methods can further comprise making the plurality of nanostructured metal oxide crystals (e.g., using colloidal methods). In some examples, the methods can further comprise removing ligands and/or capping agents from the plurality of nanostructured metal oxide crystals such that the plurality of nanostructured metal oxide crystals can be substantially free of ligands and/or capping materials.

Methods of Use

Also provided herein are methods of use any of the composite films described herein. For example, the composite films described herein can be used in electrolysis, in reversible electrodialysis, in chloroalkali systems, or combinations thereof. In some examples, the composite films described herein can be used as a proton exchange membrane, as an ion exchange membrane, as a hydrogen separation membrane, as a solid electrolyte, or a combination thereof. In some examples, the composite films described herein can be used in a fuel cell. The composite films can, for example, be used as the proton exchange membrane in a proton exchange membrane fuel cell (PEMFC). In some examples, the methods of use can be conducted at a temperature of 25° C. or more (e.g., 30° C. or more, 35° C. or more, 40° C. or more, 45° C. or more, 50° C. or more, 60° C. or more, 70° C. or more, 80° C. or more, 90° C. or more, 100° C. or more, 150° C. or more, 200° C. or more, 250° C. or more, 300° C. or more, 350° C. or more, 400° C. or more, 450° C. or more, 500° C. or more, or 550° C. or more). In some examples, the

In some examples, the composite films described herein can be used in various articles of manufacture or devices including fuel cells, electrolytic cells, proton exchange electrolyzers, and batteries. Such articles of manufacture and devices can be fabricated by methods known in the art. In some examples, the articles of manufacture or devices can be operated at a temperature of 25° C. or more (e.g., 30° C. or more, 35° C. or more, 40° C. or more, 45° C. or more, 50° C. or more, 60° C. or more, 70° C. or more, 80° C. or more, 90° C. or more, 100° C. or more, 150° C. or more, 200° C. or more, 250° C. or more, 300° C. or more, 350° C. or more, 400° C. or more, 450° C. or more, 500° C. or more, or 550° C. or more).

The examples below are intended to further illustrate certain aspects of the methods and compounds described herein and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

One defining characteristic of nanomaterials is a high surface to volume ratio. While simple, this key characteristic shifts the properties of a material to one dominated by surfaces, allowing significant deviation of overall properties from their bulk counterpart. An interface driven property within the context of ion transport materials is the intermediate temperature (300° C. to 100° C.) proton conduction in porous nanocrystalline metal oxides systems such as cerium oxide, zirconium oxide, and titanium oxide. Prior work on metal oxides has established these materials as poor proton conductors in their bulk form. However, when they are made nanosized and porous, these same materials can exhibit significant proton conductivity under humid conditions; this deviation can be attributed to the change in interface density moving from bulk to nanocrystalline sizes and introduction of a solid-vapor interface to enable ion transport.

The discovery of intermediate temperature proton conduction for these materials is in line with current interest to run proton exchange membrane fuel cells (PEMFCs) and electrolysis at elevated temperatures. This push for higher temperatures is rationalized by three primary reasons. First, there are gains in electrochemical efficiency and catalytic rates at elevated temperatures, which can be particularly important for the slow oxygen reduction reaction or oxygen evolution reaction. Second, fuel cells operated at higher temperatures can be more tolerant of impurities in the gas stream, such as CO and H₂S, which can cause poisoning of the catalysts at the anode and cathode. Third, device design can be simplified by removing the need for external heat management and complicated water management. However, the operation temperature of current PEMFCs is limited by the operation temperature of the proton exchange membrane (mostly Nafion) that dehydrates at temperatures above 80° C., leading to a significant loss in proton conductivity above 80° C. Efforts to open the temperature window for operation have yielded new proton conducting materials, such as: solid acids like CsHSO₄, BaZrO₃ and BaCeO₃ ceramics; sol-gel silica glasses; metal organic frameworks; silica phosphotungstic acid hybrids; and polymer-phosphoric acid hybrids, such as a physical mixture of polybenzimidazole or polyether pyridine with phosphoric acid or poylphosphoric acid.

Building upon an understanding of intermediate temperature proton conduction exhibited by porous nanocrystal structures, further investigations revealed that proton conductivity can be limited not by the formation of protons through the dissociation of water on the nanocrystal surface, but rather by the lack of a matrix through which protons can be conducted. At elevated temperatures from 100° C. and above, the amount of adsorbed water on a porous nanocrystal structure is estimated to be at most one or two layers thick, decreasing as temperature increases. An appropriate ion-conducting matrix can be introduced to boost ionic conductivity in the system. The final product is an inorganic-organic material, such as a nanocrystal-polymer composite, where the nanocrystal functions as the source of protons in the system, and the polymer functions as the conducting matrix for the protons. Previous attempts of boosting the performance of proton exchange membranes with the addition of inorganic components were based upon the idea of conserving water in the system either by having hydrophilic surfaces or microporosity that can promote capillary condensation. The approach described herein, on the other hand, is based upon the interfacial proton conductivity exhibited by porous nanocrystalline metal oxides.

Herein, the aforementioned concept is demonstrated, including the boost in conductivity upon introduction of an appropriate proton conducting matrix. The demonstration harnesses the phenomena of intermediate temperature proton conductivity of metal oxide surfaces and boosts conductivities into proton conducting performances relevant for device operations, be it for elevated temperature fuel cells or electrolysis.

Methods

Nanocrystal Synthesis

In a typical synthesis of 4 nm cerium oxide nanocrystals, 0.868 g of cerium nitrate hexahydrate (2 mmol, Sigma 99.999%) and 5.36 g oleylamine (20 mmol, 90% Acros Organics) were dissolved in 10 ml 1-octadecene (Aldrich 90%). After initial mixing, the solution was stirred under nitrogen at 80° C. for one hour, followed by degassing at 120° C. for one hour under <100 mTorr vacuum. The solution was then heated to 230° C. Once the solution temperature reached 230° C., the solution was further heated to 250° C. and left to react at 250° C. for two hours. After two hours, the solution was left to cool in air to below 80° C., at which point 5 mL of toluene was added into the solution. The mixture was then centrifuged at 1500 rpm for 10 minutes to remove bulk precipitates. The supernatant was mixed with 60 mL of isopropanol and centrifuged at 7000 rpm for 10 minutes. The nanocrystals were washed three times post synthesis with a hexane/isopropanol combination for dispersion and precipitation, filtered using a 0.2 μm PTFE filter, and stored.

Ligand Exchange

For a typical ligand stripping procedure, nanocrystals suspended in hexane (Aldrich >95% n-hexanes) were purified with four cycles of suspension and precipitation with hexane and reagent alcohol or acetone. The nanocrystal concentration was then diluted to 5 mg/mL, and an equivalent volume of N,N-dimethylformamide (DMF) (Aldrich ≥99%) was added to form a two phase mixture. Then, the two-phase mixture was agitated to ensure proper washing of the nanocrystals prior to ligand stripping. If the two phase mixture turned cloudy upon agitation, the nanocrystals were precipitated and washed two more times and the test repeated. If the mixture remained clear and phase separated back into a two-phase mixture, nitrosyl tetrafluoroborate (Aldrich 95%) equivalent to half or up to the approximate weight of nanocrystals in solution was added into the mixture, and the mixture was then sonicated for thirty minutes to promote ligand stripping. After the phase transfer from hexane to DMF, the hexane phase was removed and replaced with fresh hexane and shaken. After phase separation, the hexane phase was removed, and this hexane washing was repeated twice more. Then, the nanocrystals in DMF were purified with a DMF/toluene combination for suspension and precipitation, were purified up to six times tracking the DMF/toluene ratio that changes from 1:2, 1:3, 1:4 and finally to a 1 to 6 ratio of DMF to toluene. For the final wash, the nanocrystals were resuspended in 500 μL of DMF followed by an addition of 500 μL of ethanol. The nanocrystal solution was then crashed with toluene and resuspended in anhydrous DMF and stored.

Polymer-Nanocrystal Solution Preparation

To prepare the composite solution, ligand stripped nanocrystals were mixed with another polymer solution in an appropriate solvent (dimethylformamide, dimethylacetamide, acetonitrile) and left to mix for at least 30 minutes. Volume fractions were adjusted using the bulk densities of the nanocrystal and the polymer. Typical solution concentrations were on the order of 20-100 mg/ml for the nanocrystal and 1-20 mg/ml of polymer

Thin-Film Deposition

Silicon wafers or quartz substrates were cleaved to 1 cm by 1 cm substrates and cleaned using stepwise sonication for 15 minutes in Hellmanex, ethanol, chloroform, acetone, and isopropanol, and the cleaned by UV ozone for 15 minutes. For a typical ˜400 nm film, the polymer-nanocrystal films were spin-casted using 20 μL of composite solution at 1000 rpm for 3 minutes with a 2 second ramp, followed by a drying step at 4000 rpm for 1 minute.

Platinum Contact Deposition

A 400 nm film of Pt was sputtered onto the top surface of the nanocrystal film with a shadow mask that defines a 1 mm gap in the middle using a Cooke RF sputtering system operating at 60 Watts and 1.5 millitorr Ar pressure at a deposition rate of 10 nm/min. The chamber pressure was pumped down to <le-6 Torr prior to the introduction of Ar to minimize extraneous contamination from oxygen.

Impedance Spectroscopy

Impedance spectroscopy was performed in two-point configuration using a Novocontrol Alpha-A impedance analyzer over a frequency range of 1 MHz to 1-10 Hz, with a voltage amplitude of 0.12 V, using a custom stage that allowed independent temperature and environmental control. Inert gases were passed through an oxygen trap (Agilent OT1-4), and all gases were passed through CO₂ and H₂O traps prior to flowing into the stage. Humidity was introduced into the cell by bubbling the solution through water set at 17° C., corresponding to pH₂O˜20 mbar. The samples were equilibrated for six hours at 450° C., and two hours at all other temperatures in between 450° C. and 100° C., with one measurement from 1 MHz to 1 Hz or 0.1 Hz every 30 minutes after an initial equilibration of 30 minutes at each temperature. Conductivity values were normalized to film thicknesses of the samples. Oxygen partial pressure was measured with a Cambridge Sensotech Rapidox 2100 Oxygen Analyzer.

Results

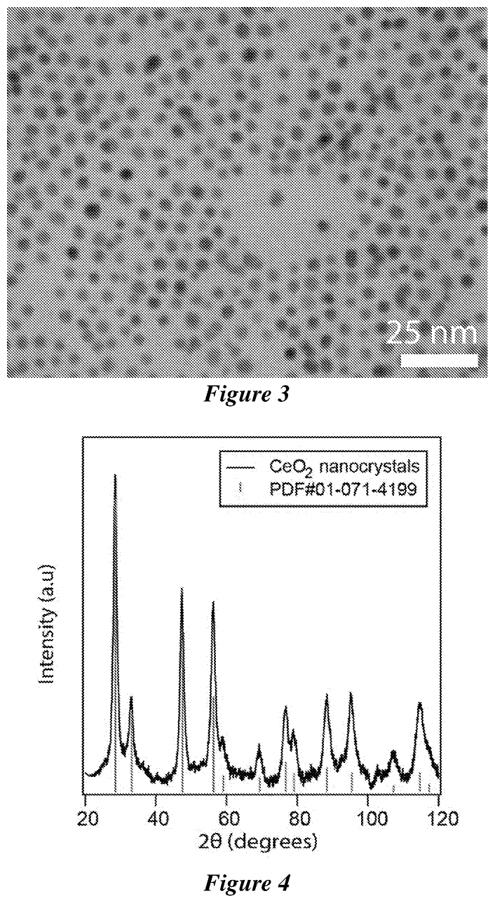

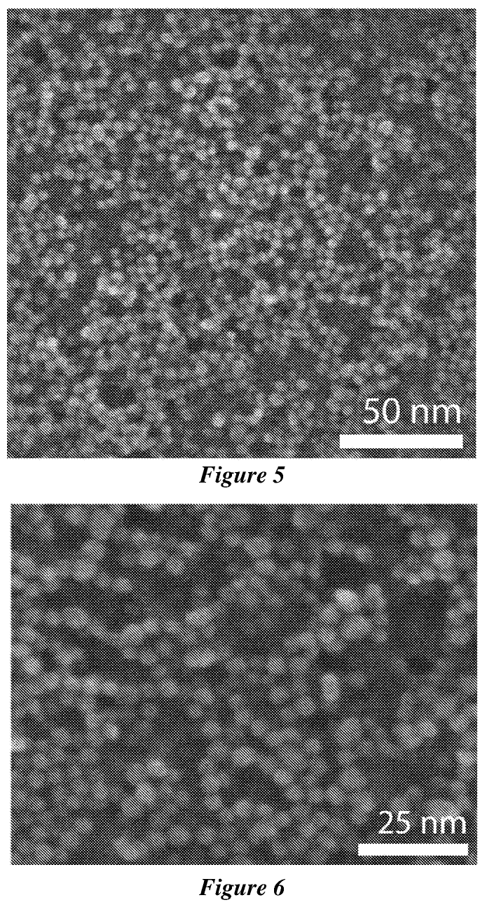

Shown in FIG. 3-FIG. 6 are prototypical material examples for the fabrication of a nanocrystal-polymer composite used to demonstrate the concept outlined above. FIG. 3 shows the transmission electron microscopy and FIG. 4 shows the X-ray diffraction pattern for cerium oxide nanocrystals used to imbue the composite material with intermediate temperature proton conduction properties. The nanocrystal material had an average diameter of 4 nm and was indexed to the standard cubic fluorite structure of cerium oxide. FIG. 5 and FIG. 6 are scanning electron microscopy images of cerium oxide-polymer composites fabricated at a 50:50 volume fraction. The nanocrystals appear bright in FIG. 5 and FIG. 6 against the polymer that appears in darker grey.

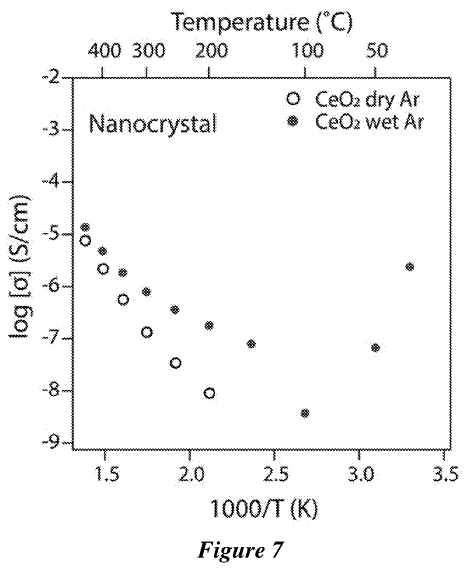

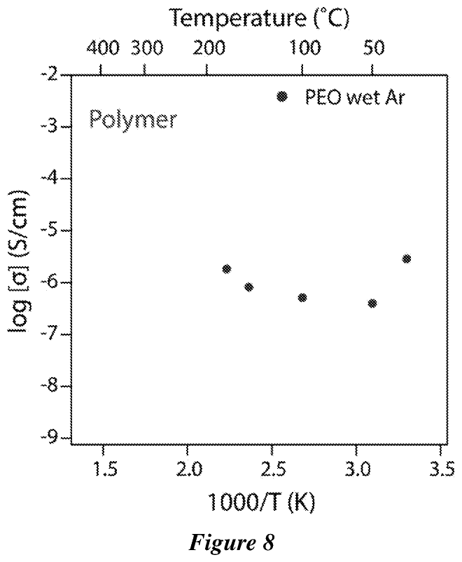

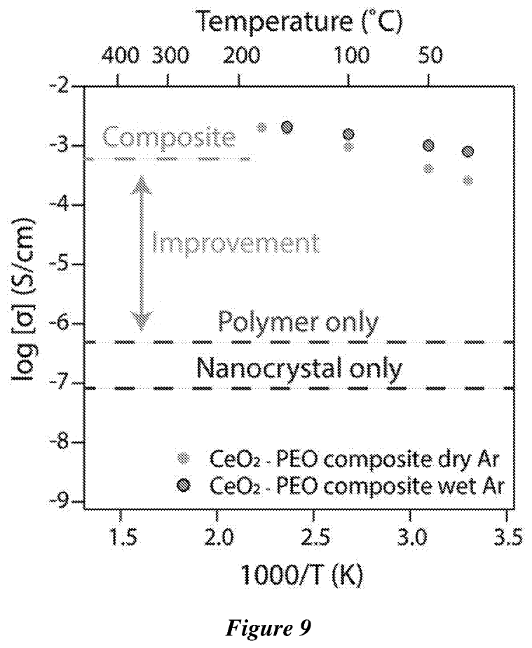

Shown in FIG. 7-FIG. 9 is a prototypical improvement in performance observed for the nanocomposite versus its individual counterparts. FIG. 7 and FIG. 8 are the conductivities of the nanocrystal only film and the polymer only film, respectively. FIG. 9 illustrates the 2 orders of magnitude improvement in ionic conductivity for the nanocomposite over its individual counterparts. For this demonstration, a standard ether polymer (polyethylene oxide) that is known to be a decent ionic conductor was used to form the composite materials. PEO has a limited thermal stability window below 200° C. Nevertheless, both the nanocrystal only case (FIG. 7) and the PEO only case (FIG. 8) exhibited poor ionic conductivity. For the former, the low ionic conductivity can be due to the absence of a conducting matrix to impart mobility for ionic conductivity. For the latter, the low ionic conductivity can be due to the absence of ions with which to conduct. Once the components were combined, a composite that exhibited appreciable ionic conductivity, reminiscent of PEO mixed with standard ionic salts, was observed (FIG. 9). This enhanced conductivity was mildly temperature dependent and was further improved by the presence of a humid “wet” environment, due to the dissociative adsorption of water on the surface of cerium oxide for the generation of additional mobile protons.

### Example 2

Proton exchange membranes are used to transport protons between the anode and cathode during charging and discharging in proton exchange membrane fuel cells (PEMFCs) or in some electrochromic devices. There are a variety of materials that possess proton-conducting properties ranging from polymeric systems, such as Nafion, to all-inorganic systems, such as solid acids.

One of the most important challenges for polymeric ion exchange membranes, specifically in proton exchange membranes, at high temperatures is water management as they rely on water for the mobile protons that are responsible for the protonic conductivity. Many polymeric systems, and particularly Nafion, dehydrate above the boiling point of water (100° C.) and subsequently lose their conducting properties. For example, the incumbent polymeric material for proton exchange membranes in PEMFCs is Nafion, which is conductive below 100° C. but above 100° C., Nafion dehydrates and the material no longer exhibits good conductivity. All-inorganic systems such as the solid acids are inherently unstable at operational conditions due to their sensitivity to humidity. Cumulatively, these limitations directly result in an upper operational temperature window for proton exchange membrane fuel cells (PEMFCs) of 90° C. This is in direct conflict with a current push to run PEMFCs at higher temperatures, e.g. above 100° C., for gains in electrochemical efficiency and stability, e.g., fuel cells can operate with faster kinetics, higher voltage gain, and less susceptibility to coking at higher temperatures. Also, at higher operation temperatures thermal energy can assist activation in the catalytic process in the PEMFCs, there are reduced mass diffusion losses, and the platinum catalyst is less susceptible to carbon monoxide poisoning.

Porous proton transporting composites comprising nanoscale metal oxides exhibit intermediate temperature proton conduction (100° C. to 300° C.) under humidified conditions (wet gas conditions) and can be useful as a potential proton transport membrane or electrolyte, especially at temperatures beyond 100° C. However, one of the limitations of surface mediated protonic conductivity shown by porous metal oxides under humidified conditions is a limited absolute conductivity despite their persistence at high temperatures. More specifically, the proton conductivity of such nanoscale metal oxides is still orders of magnitude lower than what is required for practical proton transport materials (10⁻⁶ S/cm with current industry requirement of >10⁻³ S/cm for fuel cell applications).

Described herein are nanostructured inorganic-organic composites which can be used as solid electrolytes for proton conduction at intermediate temperatures (e.g., 100° C. or more, 200° C. or more, up to 300° C.). The composite materials can exhibit high ionic conductivity from 100° C. to 200° C. or more, comparable to current state-of-the-art polymeric conducting membranes (improving on these at the higher temperatures within this range). Additionally, the composite materials demonstrate up to a 5 orders of magnitude increase in conductivity compared to the inorganic-only system comprising the metal oxide only. The composite materials can extend the operational window for proton exchange membranes with good usable conductivity well above 100° C., up to 200° C. or more, allowing construction of fuel cells that can operate more efficiently with faster kinetics, higher voltage gain, and less susceptibility to coking.

Disclosed herein are compositions of composite organic-inorganic proton conductive materials comprised of a nanosized high surface area crystalline metal oxide and an organic conducting matrix, and methods of making said compositions. The composite materials utilize a nanocrystalline metal oxide that demonstrates preferential adsorption of water on its surface and water dissociation at defect sites to both retain water and generate mobile protons. The composite materials also utilize introduction of an organic matrix, either by ex situ or in situ means, to provide a conductive pathway for the protons, to thereby dramatically increase the absolute ionic conductivity of the composite material.

The composite materials described herein build upon the intermediate temperature proton conduction on the open surfaces of metal oxides by augmenting the conductivity with a polymer matrix that forms an interfacial region with a porous, nanostructured metal oxide and facilitates conductivity, increasing the conductivity an acceptable level for practical applications. To demonstrate this concept, an in situ polymerization process was used to form an example composite material and, as a result, an enhancement in stable proton conductivity of almost 5 orders of magnitude was observed. The in situ process is scalable and can be directly applied, especially in the case of thin film electrolytes. Thus, the composite material and methods of making thereof can be cost effective and durable. The composite materials described herein can be used in: fuel-cells, proton exchange membranes, ion exchange membranes, and reversible electrodialysis.

The proton transport in the composite materials described herein can be enhanced by coating the metal oxide surface with a proton transporting polymer matrix. Many such polymers are known from previous development of polymer only and hybrid polymer-inorganic electrolytes, one such class of polymers is polyethers, like polytetrahydrofuran. In a demonstration of the composite materials, thin layers of polytetrahydrofuran were in situ deposited into porous CeO₂ nanocrystal films, which significantly increased the proton conductivity (up to 5 orders of magnitude) by providing a matrix for proton conductivity. Further, the conductivity of the composite material persisted into the higher, intermediate temperature regime where previous polymer-based proton conductors have typically faltered.

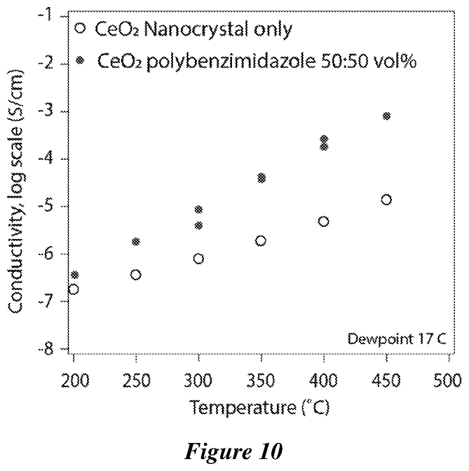

Shown in FIG. 10 are the results showing an improvement in performance observed for a nanocomposite versus CeO₂ nanocrystals only wherein the polymer used to form the composite was polybenzimidazole (composite was tested twice). FIG. 10 illustrates a 2 orders of magnitude improvement in ionic conductivity for the nanocomposite over the CeO₂ nanocrystals alone at 450° C.

Herein, polymeric materials and inorganic metal oxides were combined to create a synergistic composite material where the metal oxide provides protonic retention at elevated temperatures while the polymeric matrix provides an efficient conductivity pathway. These composite materials are applicable to any type of interface driven proton transport devices, such as ion exchange membranes and, specifically, proton exchange membranes for proton exchange membrane fuel cells or micro-fuel cells.

The compositions, devices, and methods of the appended claims are not limited in scope by the specific devices and methods described herein, which are intended as illustrations of a few aspects of the claims and any devices and methods that are functionally equivalent are within the scope of this disclosure. Various modifications of the compositions, devices, and methods in addition to those shown and described herein are intended to fall within the scope of the appended claims. Further, while only certain representative compositions, devices, and methods, and aspects of these compositions, devices, and methods are specifically described, other compositions, devices, and methods and combinations of various features of the compositions, devices, and methods are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

1. A composite film comprising a plurality of nanostructured metal oxide crystals dispersed within a proton conducting polymer phase, wherein the plurality of nanostructured metal oxide crystals have an average particle size of from 1 nm to 20 nm, and wherein the composite film comprises from 20% to 90% by volume of the plurality of nanostructured metal oxide crystals relative to the composite film.

2. The composite film of claim 1, wherein the plurality of nanostructured metal oxide crystals comprise a reducible metal oxide.

3. The composite film of claim 1, wherein the plurality of nanostructured metal oxide crystals comprise niobium oxide, titanium oxide, tungsten oxide, zirconium oxide, hafnium oxide, magnesium oxide, vanadium oxide, iron oxide, chromium oxide, manganese oxide, nickel oxide, cerium oxide, gadolinium oxide, samarium oxide, or a combination thereof.

4. (canceled)

5. The composite film of claim 1, wherein the plurality of nanostructured metal oxide crystals comprise cerium oxide.

6. The composite film of claim 1, wherein the plurality of nanostructured metal oxide crystals comprise cerium oxide doped with one or more dopants.

7. The composite film of claim 1, wherein the plurality of nanostructured metal oxide crystals comprise gadolinium doped cerium oxide, samarium doped cerium oxide, or a combination thereof.

8. The composite film of claim 1, wherein each of the plurality of nanostructured metal oxide crystals has at least one dimension that is from 1 nm to 5 nm in size.

9. (canceled)

10. The composite film of claim 1, wherein the plurality of nanostructured metal oxide crystals have an average particle size of from 1 nm to 10 nm.

11. The composite film of claim 1, wherein the plurality of nanostructured metal oxide crystals are substantially free of ligands and/or capping materials.

12. The composite film of claim 1, wherein the proton conducting polymer phase comprises a polyether, a polysulfonate, a polysulfone, a poly(imidazole), a triazole, a benzimidazole, a polyester, a polycarbonate, a polymer derived from a pyridine monomer, derivatives thereof, or combinations thereof.

13. (canceled)

14. The composite film of claim 1, wherein the proton conducting polymer phase comprises polyethylene oxide, polyetherpyridine, polyether ether ketone (PEEK), polytetrahydrofuran, polyvinyl butyral, polybenzimidazole, derivatives thereof, or combinations thereof.

15. (canceled)

16. The composite film of claim 1, wherein the composite film comprises from 30% to 90 by volume of the plurality of nanostructured metal oxide crystals relative to the composite film.

17. The composite film of claim 1, wherein the composite film has an average thickness of from 100 nm to 500 μm.

18. The composite film of claim 1, wherein the composite film has a proton conductivity of 10⁻⁸ S/cm or more at a temperature of 100° C. or more.

19. (canceled)

20. (canceled)

21. A method of making the composite film of claim 1, the method comprising:
dispersing the plurality of nanostructured metal oxide crystals and the polymer comprising the proton conducting polymer phase in a solvent, thereby forming a dispersion; and
depositing the dispersion on a substrate;
thereby forming the composite film.

22. (canceled)

23. (canceled)

24. (canceled)

25. (canceled)

26. The method of claim 21, further comprising:
removing the composite film from the substrate;
making the plurality of nanostructured metal oxide crystals;
removing ligands and/or capping agents from the plurality of nanostructured metal oxide crystals such that the plurality of nanostructured metal oxide crystals can be substantially free of ligands and/or capping materials;
or a combination thereof.

27. (canceled)

28. (canceled)

29. A device comprising the composite film of claim 1, wherein the device comprises a fuel cell, an electrolytic cell, a proton exchange electrolyzer, or a battery.

30. (canceled)

31. (canceled)

32. A method of use of the composite film of claim 1, the method comprising using the composite film as a proton exchange membrane, as an ion exchange membrane, as a hydrogen separation membrane, as a solid electrolyte, or a combination thereof.

33. A method of use of the composite film of claim 1, the method comprising using the composite film in a fuel cell, in electrolysis, in reversible electrodialysis, in a chloroalkali system, or a combination thereof.

34. (canceled)

35. The method of claim 33, wherein the method is conducted at a temperature of 100° C. or more.

36. (canceled)
